(19) United States
(12) Patent Application Publication
(10) Pub. No.: US 2026/0228565 A1
(43) Pub. Date: Aug. 6, 2026

(54) AUTOMATED SUPPORT FOR USERS OF DATA PROCESSING SYSTEMS

(71) Applicant: Dell Products L.P., Round Rock, TX (US)

(72) Inventors: SWAGAT PARIDA, Bangalore (IN); VIVEKANANDH NARAYANASAMY RAJAGOPALAN, Bangalore (IN)

(21) Appl. No.: 19/043,693

(22) Filed: Feb. 3, 2025

(51) Int. Cl. G06N 5/022

(52) U.S. Cl. CPC G06N 5/022

(57) ABSTRACT

Methods and systems for managing a data processing system are disclosed. A first set of user actions performed by a user of the data processing system while the data processing system is providing computer-implemented services may be obtained. The first set of user actions may not accomplish any desired outcomes of the user. A desired outcome of the user may be identified based on the first set of user actions and a knowledge repository that stores information regarding historical sets of user actions that lead to the any desired outcomes. Using a trained machine learning model, a second set of user actions may be inferred based on the desired outcome and at least the first set of user actions. Performance of the second set of user actions may be automatically initiated to increase a likelihood of an occurrence of the desired outcome.

### FIELD

Embodiments disclosed herein relate generally to managing data processing systems. More particularly, embodiments disclosed herein relate to systems and methods for supporting users of the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a distributed system in accordance with an embodiment.

FIGS. 2A-2C show data flow diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data processing systems that may provide computer-implemented services. For example, a downstream consumers of the computer-implemented service may include user of the data processing systems. The user may operate the data processing systems by interacting with service applications hosted by the data processing systems in order to accomplish desired outcomes (e.g., obtaining desired computer-implemented services).

To accomplish a desired outcome, a uses may be required to perform an appropriate set of user actions when interacting with the service applications. However, the user may be unable to perform the appropriate set of user actions for various reasons (e.g., due to being unseasoned, due to software bugs and/or incorrect configuration of the service applications). If the user is unable to perform the appropriate set of user actions, then the user may be unable to accomplish the desired outcome and/or be provided with the desired computer-implemented services (e.g., end-to-end computer-implemented services). This may result in user dissatisfaction, negative User Experience (UX) scores, abandonment of the computer-implemented services by the user, etc. In some situations where the user is unable to accomplish the desired outcome, the user may request support.

However, manually supporting individual needs of each user of the data processing systems may be resource intensive, may present delays in the users being provided with the desired computer-implemented services, and in some cases may not result in the users being provided with the desired computer-implemented services. For example, providing manual support for complex systems (e.g., data processing systems, docks, peripherals) may be manually intensive, tedious, and time consuming, and/or support services may fail to provide adequate support (e.g., as specified by a service level agreement).

Thus, to increase a likelihood of providing the desired computer-implemented services to the users, automated user support may be provided. To do so, a first set of user actions performed by a user (e.g., that do not accomplish any desired outcomes of the user) may be used to identify (e.g., predict) a desired outcome of the user. Based on the desired outcome and the first set of user actions, a second set of user actions may be inferred that, when performed, may increase a likelihood of an occurrence of the desired outcome. Performance of the second set of user actions may be automatically initiated, and the second set of user actions may be performed on behalf of the user and/or the user may be assisted in performing at least a portion of the second set of user actions.

By doing so, users of the data processing systems may be more likely to accomplish desired outcomes timely when interacting with the service applications, and the computer-implemented services may be more likely to be provided as desired.

In an embodiment, a method for managing service systems is provided. The method may include: obtaining a first set of user actions performed by a user of the data processing system while the data processing system is providing computer-implemented services, the first set of user actions not accomplishing any desired outcomes of the user; identifying a desired outcome of the user based on the first set of user actions and a knowledge repository that stores information regarding historical sets of user actions that lead to the any desired outcomes; inferring, using a trained machine learning model, a second set of user actions based on the desired outcome and at least the first set of user actions; and, automatically initiating performance of the second set of user actions to increase a likelihood of an occurrence of the desired outcome.

The first set of user actions may be obtained while the user interacts with at least two applications hosted by the data processing system.

Identifying the desired outcome may include: identifying a set of likely desired outcomes based on correlations between the historical sets of user actions and the first set of user actions; obtaining a rank ordering of the historical sets of user actions based on the correlations; and, selecting the desired outcome based on an association between a best ranked set of the historical sets of user actions and one of the desired outcomes.

Inferring the second set of user actions may include ingesting at least one of the desired outcome and the first set of user actions as input to the trained machine learning model to generate the second set of user actions as output from the trained machine learning model.

The trained machine learning model may be based on a machine learning model architecture that is trained using the knowledge repository.

Automatically initiating performance of the second set of user actions may include: presenting the desired outcome and at least a second desired outcome to the user; and, obtaining user input from the user indicating a preference with respect to the desired outcome and the at least the second desired outcome.

Automatically initiating performance of the second set of user actions may further include, in an instance of the obtaining where the user input indicates that the preference is with respect to the desired outcome, activating an automation framework hosted by the data processing system to perform the second set of user actions on behalf of the user.

Automatically initiating performance of the second set of user actions may further include, in an instance of the obtaining where the user input indicates that the preference is with respect to the desired outcome, activating an automation framework hosted by the data processing system to sequentially assist the user in performing actions of the second set of user actions.

A non-transitory media may include instructions that when executed by a processor cause the computer-implemented method to be performed.

The data processing system may include the non-transitory media and a processor, and may perform the computer-implemented method when the computer instructions are executed by the processor.

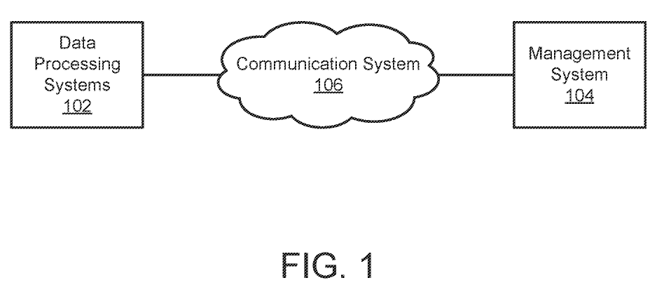

Turning to FIG. 1, a block diagram illustrating a distributed system in accordance with an embodiment is shown. The system shown in FIG. 1 may provide computer-implemented services. The computer-implemented services may include any type and quantity of computer-implemented services. For example, the computer-implemented services may include communication services, data storage services, database services, data generation services, and/or any other type of service that may be implemented with a computing device. The computer-implemented services may be provided to downstream consumers, including users of the data processing systems.

To provide the computer-implemented services, the system may include any number of computing devices (e.g., data processing systems). The data processing systems may include any quantity of software components, hardware components, and/or peripheral components (e.g., external network devices, external storage devices, docking stations). The hardware components may include, for example, processors, memory modules, storage devices, communications devices, power components, software applications, device drivers, and/or any other type of component whose respective operation may facilitate various functionalities of the data processing systems. Users of the data processing systems may interact with the components in order to be provided with the computer-implemented services.

For example, the users may operate the data processing system by interacting with service applications hosted by the data processing system. The user may perform various actions (e.g., user actions) in order to accomplish a desired outcome, such as obtaining desired (e.g., uninterrupted, end-to-end, and/or otherwise expected) computer-implemented services. For example, while interacting with the service applications, the user may perform user actions. However, if the user is unseasoned, the components are not configured as expected by the user (e.g., due to updates to the service applications), and/or for other reasons (e.g., failures of components, software bugs), then the performance of the user actions may not accomplish any desired outcomes of the user.

As a result, the user may be dissatisfied with the computer-implemented services (e.g., UX scores may be reduced), the user may abandon use of the computer-implemented services, and/or the user may require support in order to accomplish the desired outcome. However, providing manual support (e.g., using support technicians) for multiple users of multiple data processing systems, each with potentially unique issues, may be resource intensive and/or may lead to disruptions to (e.g., delays in) provisioning of the desired computer-implemented services. In addition, providing manual support for complex systems with multiple component types (e.g., peripherals, docks, specialized hardware) may require specialized knowledge (e.g., by the support technicians). Therefore, lack of the specialized knowledge may result in failures to provide adequate support (e.g., failures to meet service level agreement obligations).

In general, embodiments disclosed herein may provide methods, systems, and/or devices for providing automated support for users of data processing systems in a manner that increases likelihoods of occurrences of desired outcomes for the users. To do so, a first set of user actions performed by a user of a data processing system may be obtained. If the first set of user actions do not accomplish a desired outcome for the user, then the user actions may be analyzed using a knowledge repository that stores information regarding historical sets of user actions and associated outcomes in order to identify a likely desired outcome for the user. The user may be prompted to confirm a desired outcome. Based on the desired outcome, a trained machine learning model may be used to infer a second set of user actions that, when performed, may be likely to accomplish the desired outcome.

To provide automated support for the user, the second set of user actions may be automatically initiated. For example, an automation framework may be activated to perform the second set of user actions. Actions of the second set of user actions may be performed on behalf of the user and/or the user may be assisted in performing at least a portion of the second set of user actions. By doing so, interruptions to the computer-implemented services may be reduced (e.g., prevented) and the user may be more likely to accomplish the desired outcome timely and without relying on manual support.

To provide the above-mentioned functionality, the distributed system of FIG. 1 may include data processing systems 102, management system 104, and communication system 106. The distributed system, any components thereof, and/or any other types of devices or components not shown in FIG. 1 may perform all, or a portion of the computer-implemented services independently and/or cooperatively. Each of these components is discussed below.

Data processing systems 102 may include any number of data processing systems. Any of data processing systems 102 may be operated by users directly and/or indirectly (e.g., via other devices). Data processing systems 102 may host various service applications with which the users may interact to obtain and/or facilitate provision of the computer-implemented services. Data processing systems 102 may include functionality for recording and/or reporting user actions performed while data processing systems 102 are providing the computer-implemented services. To facilitate automated support for the user, data processing systems 102 may communicate (e.g., exchange data) with management system 104.

Management system 104 may include any number of data processing systems and may provide a variety of services for data processing systems 102. For example, management system 104 may provide monitoring services, data analysis services, automated user support services, and/or management services. Management system 104 may provide the services, at least in part, to facilitate automated support for users of data processing systems 102.

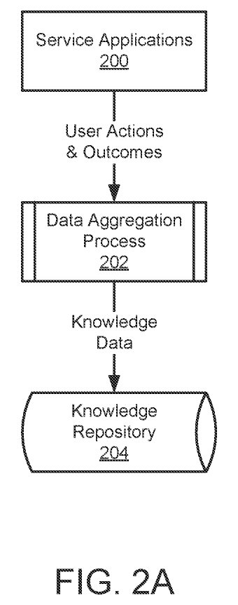

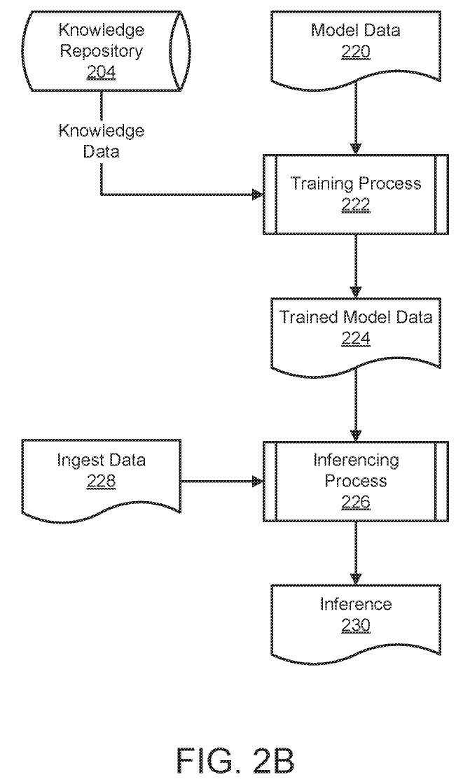

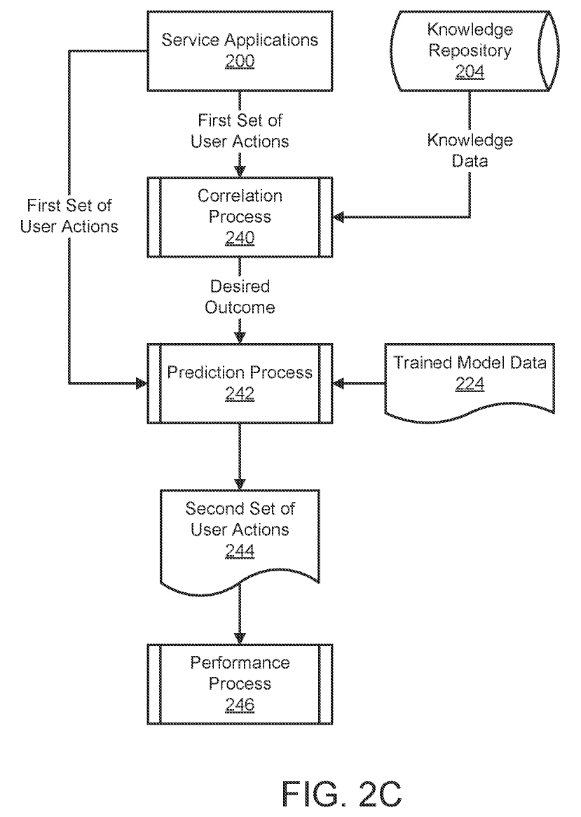

Management system 104 may manage and/or have access to a knowledge repository that stores knowledge data. The knowledge data may include information regarding historical sets of user actions and associated outcomes (e.g., desired outcomes for the users). For example, to maintain the knowledge repository, management system 104 may monitor operation of data processing systems 102 over time in order to obtain sets of user actions performed by the users operating data processing systems 102. The user actions may be stored in the knowledge repository along with outcomes that occur as results of the sets of user actions. Management system 104 may, for example, use the knowledge data to train machine learning models and/or correlate sets of user actions with likely outcomes when facilitating automated user support services. Refer to the discussion of FIG. 2A for more details regarding knowledge data.

Management system 104 may host any number of trained machine learning models. For example, management system 104 may include functionality for obtaining the trained machine learning models (e.g., training the machine learning models) and/or using the trained machine learning models to obtain inferences. The trained machine learning models may be trained, for example, to provide information usable to facilitate the automated user support services. Refer to the discussion of FIG. 2B for more details regarding machine learning models.

For example, to provide automated support for a user of at least one of data processing systems 102, management system 104 may (i) obtain a first set of user actions performed by the user, (ii) identify a desired outcome of the user (e.g., by correlating the first set of user actions to historical user actions stored in the knowledge repository), (iii) infer a second set of user actions (e.g., by providing the second set of user actions and/or the desired outcome to a machine learning model trained to predict user actions), (iv) automatically initiate performance of the second set of user actions (e.g., using an automation framework), and/or (v) perform other actions relating to managing outcomes of the user. Refer to the discussion of FIG. 2C for more details regarding automated support services.

By doing so, management system 104 may provide automated user support in a manner that increases a likelihood of the user accomplishing the desired outcome.

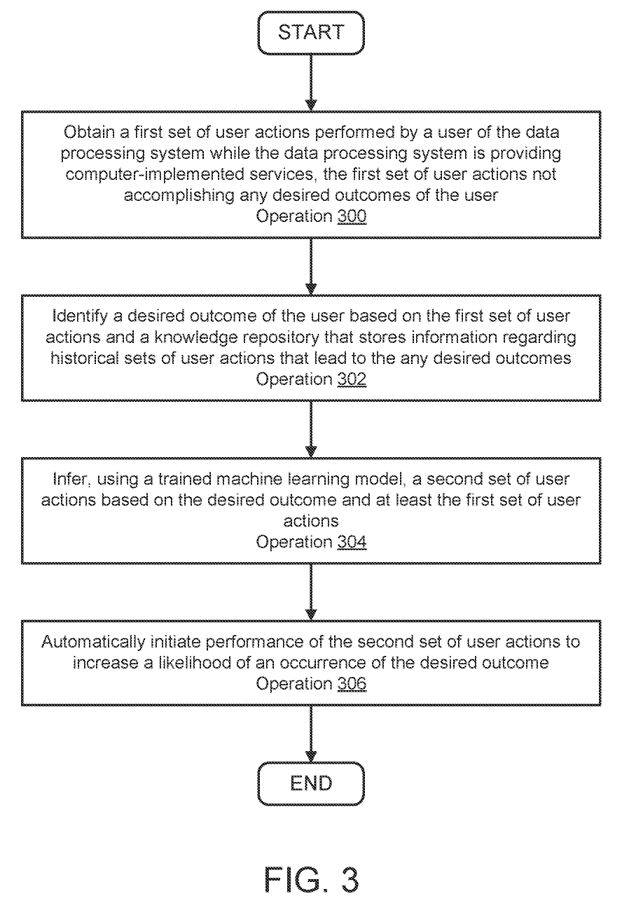

When providing their functionality, any of data processing systems 102, management system 104, and/or components thereof may perform all, or a portion of the actions and methods illustrated in FIGS. 2A-3.

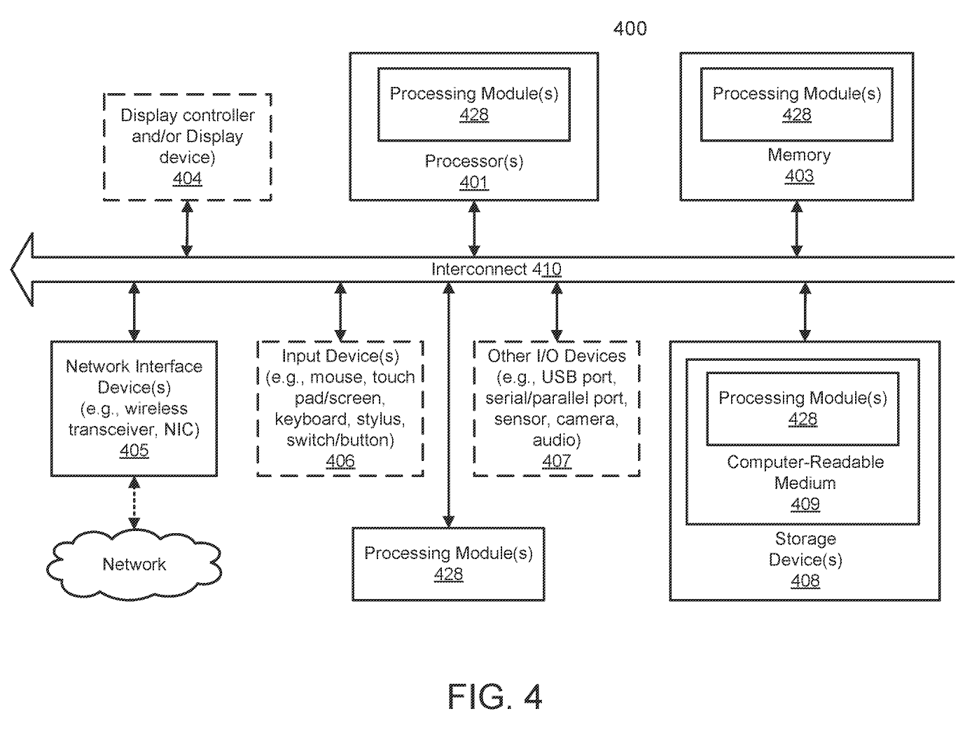

Any of data processing systems 102 and management system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 220, 224, etc.) is used to represent data structures, a second set of shapes (e.g., 202, 222, etc.) is used to represent processes performed using and/or that generate data, a third set of shapes (e.g., 204) is used to represent large scale data structures such as databases, and a fourth set of shapes (e.g., 200) is used to represent software components.

Turning to FIG. 2A, a first data flow diagram in accordance with an embodiment is shown. The first data flow diagram may illustrate data used in and data processing performed in obtaining knowledge data.

To obtain the knowledge data, data aggregation process 202 may be performed. During data aggregation process 202, user actions and outcomes may be obtained from service applications 200. Service applications 200 may include any number and/or type of service application (e.g., software components) hosted by data processing systems and/or otherwise accessible by a user of the data processing systems. For example, two or more service applications may be used by a user (e.g., web-based applications, mobile applications) in order to obtain computer-implemented services.

The user may interact with service applications 200 by performing actions (e.g., user actions), which may include mouse clicks, hovering, scrolling, keyboard strokes, and/or other actions that may activate features of service applications 200 (e.g., accessing data via service applications 200, accessing functionality of service applications 200). When sets of user actions (e.g., one or more user actions) are performed, features of service applications 200 may activated and/or a desired outcome of the user may be accomplished. For example, the user may perform actions to access and generate data (e.g., reports) using any of service applications 200. The sets of user actions may include workflows (e.g., a set of user actions performed in a particular sequence).

To obtain the user actions (e.g., sets thereof) and outcomes, a management entity (e.g., management system 104) may monitor operation of service applications 200 and/or service applications 200 may record and/or provide the user actions and outcomes to the management entity. The user actions and outcomes may include metadata regarding the user actions such as user identifiers, timestamps, and/or features of service applications 200 (e.g., functionality) invoked by the user actions.

During data aggregation process 202, (i) identifiers (e.g., global unique identifiers) may be assigned to each user action and each outcome, (ii) outcomes may be classified as desired outcomes or failed outcomes (e.g., undesired outcomes). For example, an outcome may be classified as desired if the user was able to invoke the feature and/or invoke the feature efficiently (e.g., by performing a threshold number of user interactions), or the outcome may be classified as failed if the user was unable to invoke the feature (e.g., efficiently). Processed (e.g., identified, classified, and/or otherwise sanitized) user actions and outcomes may be associated and/or structured representations of user actions and outcomes may be obtained.

For example, during data aggregation process 202, knowledge graphs (e.g., acyclic graphs) may be populated using the processed user actions and outcomes. The knowledge graphs may include, for example, entities (e.g., outcomes) connected by relationships (e.g., user actions). Each entity may include attributes (e.g., metadata, classifications of desired or failed). The knowledge graphs may represent sequences of user actions (e.g., workflows) that lead to outcomes.

The knowledge data (e.g., structured representations thereof) may be stored in knowledge repository 204. Knowledge repository 204 may be managed (e.g., maintained) by the management entity and/or other systems. Knowledge repository 204 may include any quantity of knowledge data regarding user actions and outcomes obtained from a variety of service applications hosted by a data processing systems 102. The knowledge data stored in knowledge repository 204 may be accessed, for example, via database lookup based on a set of user actions (e.g., a subset of user actions from a knowledge graph), an outcome, and/or other keyed attributes of the knowledge data. The knowledge data may be used by the management entity to identify desired outcomes for users, to train machine learning models to associate sets of user actions with outcomes, and/or for other purposes.

Turning to FIG. 2B, a second flow diagram in accordance with an embodiment is shown. The second data flow diagram may illustrate data used in and data processing performed when facilitating operation of a machine learning model. In the example shown in FIG. 2B, the operation of the machine learning model may include a training process and an inferencing process. The training process may include, for example, initial training of an untrained model, retraining of a trained machine learning model, and/or fine-tuning of a trained machine learning model. The inferencing process may include, for example, obtaining inferences using the trained machine learning model. Other processes may be performed to facilitate operation of the machine learning model (not shown) without departing from embodiments disclosed herein.

To obtain a trained machine learning model, a management entity (e.g., management system 104) may facilitate performance of training process 222. Training process 222 may include training an untrained machine learning model defined by (untrained) model data 220.

Model data 220 may include information relating to model architecture, hyperparameters, and/or other information regarding an untrained machine learning model (e.g., optimization algorithm information, hidden layer information, bias function descriptions, activation function descriptions, etc.). A machine learning model type and/or size may be selected based on performance goals and/or constraints, training data availability and/or quality, budget, timeline, etc.

During training process 222, model data 220 may be updated using knowledge data (e.g., training data) from knowledge repository 204. As discussed with respect to FIG. 2A, the knowledge data stored in knowledge repository 204 may be obtained from any number of service applications (e.g., service applications 200), and may include a corpus of (sets of) user actions associated with outcomes, and/or structured representations thereof. As the machine learning model is exposed to large numbers of relationships and/or patterns in the knowledge data, weights and/or other parameters of model data 220 may be modified to obtain trained model data 224. Trained model data 224 may be used during inferencing processes to generate inferences in response to ingest data. For example, trained model data 224 may be used to infer sets of user actions associated with desired outcomes.

During inferencing process 226, a trained machine learning model may be obtained based on information (e.g., node information, weight information, connection information, activation functions, etc.) included in trained model data 224. The trained machine learning model may generalize relationships found in the knowledge data (e.g., relationships between sets of user actions and outcomes). During inferencing process 226, inferences may be generated based on ingest data 228.

Ingest data 228 may include a portion of data for which an inference is desired to be obtained. During inferencing process 226, ingest data 228 may be input to the trained machine learning model and the trained machine learning model may infer an output likely to be associated with the input. For example, ingest data 228 may include a first set of user actions (e.g., user actions performed by a user that do not accomplish any desired outcomes of the user) and/or a desired outcome for the user. An association for ingest data 228 (e.g., a second set of user actions associated with accomplishing the desired outcome) may not be known.

Based on ingest data 228, the trained machine learning model may generate inference 230. Inference 230 may be likely to be associated with ingest data 228 according to relationships and/or patterns generalized by the trained machine learning model during training process 222. For example, inference 230 may include a second set of user actions that, when performed, increase a likelihood of an occurrence of the desired outcome. Therefore, inference 230 may be used to provide automated user support.

Turning to FIG. 2C, a third flow diagram in accordance with an embodiment is shown. The third data flow diagram may illustrate data used in and data processing performed in obtaining user actions usable to facilitate automated support services for users of data processing systems.

To facilitate automated support services for a user of a data processing system, a management entity (e.g., management system 104) may obtain a first set of user actions while the user interacts with service applications 200. The first set of user actions may include a portion of actions required to achieve a desired outcome of the user (e.g., performed by the user while the data processing system is providing computer-implemented services). For example, the first set of user actions may be obtained while the user interacts with at least two service applications hosted by the data processing system (e.g., using a mobile phone, a laptop, and/or a tablet). The first set of user actions may not accomplish any desired outcomes of the user.

Consider an example where the user performs the first set of user actions to generate a report using service applications with features for generating reports. The first set of user actions may include actions performed while the user navigates through various menus of the service applications. In a first example, the service applications may generate an error (e.g., due to invalid user input, due to bugs and/or software failures, etc.) and/or may fail to generate the report as desired by the user. In a second example, the user may be unable to find an appropriate menu to generate the report as desired. In both examples, the user may be unable to proceed (e.g., understand and/or resolve the error, generate valid user input, find the appropriate menu, etc.) with generating the report and therefore may not accomplish a desired outcome.

To provide automated support for the user, the desired outcome of the user may be identified. To identify the desired outcome, correlation process 240 may be performed. During correlation process 240, the first set of user actions may be correlated with (e.g., compared with) portions of knowledge data from knowledge repository 204. As discussed with respect to FIG. 2A, knowledge repository 204 may store information regarding historical sets of user actions that lead to (e.g., are associated with) historical desired outcomes. Correlations (e.g., statistical relationships) between the first set of user actions and historical sets of user actions associated with desired outcomes may be obtained, for example, using any type of correlation techniques (e.g., graph similarity algorithms).

During correlation process 240, a set of likely desired outcomes may be identified based on the correlations between the first set of user actions and the historical sets of user actions. For example, a portion of desired outcomes associated with each correlated set of historical user actions may be identified. The correlated historical sets of user actions may be rank ordered, for example, based on a strength of each correlation (e.g., correlation values). For example, the correlated historical sets of user actions may be rank ordered from strongest correlation to weakest correlation. The desired outcome of the user may be selected based on an association of a best ranked set of historical sets of user actions and one of the desired outcomes.

For example, the desired outcome may include one or more desired outcomes, such as two desired outcomes associated with the two strongest correlated sets of historical user actions. In other words, the desired outcome may be the most likely desired outcome of the user based on performance of the first set of user actions. The desired outcome may be provided to prediction process 242.

Prediction process 242 may include an inferencing process similar to inferencing process 226 of FIG. 2B. For example, during prediction process 242, trained model data 224 (of FIG. 2B) may be used to obtain a trained machine learning model. The trained machine learning model may be based on a machine learning model architecture trained using (knowledge data from) knowledge repository 204. The trained machine learning model may be used to infer a second set of user actions (e.g., 244) based on the desired outcome and at least the first set of user actions. Refer to FIG. 2B for more details regarding the trained machine learning model.

For example, during prediction process 242, at least one of (i) the desired outcome, and (ii) the first set of user actions, may be ingested as input to the trained machine learning model. The trained machine learning model may use generalized relationships derived during training to generate second set of user actions 244 as output. For example, the trained machine learning model may infer second set of user actions 244 based on the desired outcome and/or the first set of user actions. Second set of user actions 244 may be a most likely set of user actions to produce the desired outcome. When two or more desired outcomes are identified during correlation process 240, second set of user actions 244 may include two or more subsets of user actions, each subset, when performed, being likely to accomplish a corresponding desired outcome of the user.

Second set of user actions 244 may be used to automatically support the user in accomplishing the desired outcome. For example, performance of actions of second set of user actions 244 may be initiated automatically during performance process 246.

During performance process 246, the desired outcome (e.g., one or more likely desired outcomes of the user identified during correlation process 240) may be presented to the user so that the user may indicate a preference with respect to the desired outcome. For example, the user may be presented with a first desired outcome and a second desired outcome. The user may provide input (e.g., via a command line interface, via a graphical user interface) indicating a preference between the first desired outcome and the second desired outcome.

Based on the user input (e.g., indicating a preferred desired outcome), performance of the second set of user actions may be initiated using an automation framework. The automation framework may include one or more applications hosted by the data processing system and/or managed by the management entity. For example, during performance process 246, the automation framework may be activated, and the automation framework may (i) perform at least one action of second set of user actions 244 on behalf of the user, and/or (ii) sequentially assist the user in performing one or more actions of second set of user actions 244. By doing so, a likelihood of an occurrence of the (preferred) desired outcome may be increased.

Returning to the above example of report generation, during performance process 246 the user may be presented with two potentially desired outcomes: “generate report type A,” or “generate report type B”. The user may indicate that generation of report type A is the desired outcome, and actions of second set of user actions 244 for accomplishing generation of report type A may be provided to the automation framework. A first portion the actions may be performed automatically (e.g., the appropriate menu may be activated), and the user may be guided through the menu options using a second portion of the actions. For example, the user may be able to navigate (e.g., understand and/or resolve) the error, provide valid user input, and/or perform other actions to accomplish generation of report type A.

The automation framework may include functionality for collecting and/or providing feedback to the management entity (and/or other systems). For example, during performance process 246, the automation framework may prompt the user for feedback, and/or may provide information regarding user actions performed during performance process 246 and outcomes accomplished during performance process 246. The feedback may be used to improve any of the components (e.g., processes, data structures) shown in FIGS. 2A-2C (and/or other components not shown that may participate in providing automated user support).

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using the data flows shown in FIGS. 2A-2C, a user may be supported automatically and in real-time using an inferred set of user actions. The inferred set of user actions may include a set of actions that, when performed, increase a likelihood of the user accomplishing a desired outcome of the user. By doing so, delays in accomplishing the desired outcome (e.g., due to user error, due to software limitations and/or errors) may be reduced or prevented, increasing a likelihood of the user being provided with desired computer-implemented services.

Turning to FIG. 3, a flow diagram illustrating a method in accordance with an embodiment is shown. The flow diagram may illustrate various operations performed while managing a data processing system.

At operation 300, a first set of user actions performed by a user of the data processing system while the data processing system is providing computer-implemented services may be obtained. The first set of user actions may be obtained by (i) reading the first set of user actions from storage, (ii) receiving the first set of using actions (e.g., from another device), and/or (iii) generating the first set of user actions. For example, the first set of user actions may be generated by the data processing system while the user interacts with two or more service applications hosted by the data processing system. The first set of user actions may not accomplish any desired outcomes of the user. For example, the user may require support in order to accomplish a desired outcome. Refer to the discussion of data aggregation process 202 of FIG. 2A for more details regarding obtaining user actions.

At operation 302, a desired outcome of the user may be identified based on the first set of user actions and a knowledge repository that stores information regarding historical sets of user actions that lead to the any desired outcomes. The desired outcome may be identified by (i) identifying a set of likely desired outcomes based on correlations between the historical sets of user actions and the first set of user actions, (ii) obtaining a rank ordering of the historical sets of user actions based on the correlations, and/or (iii) selecting the desired outcome based on an association between a best ranked set of the historical sets of user actions and one of the desired outcomes. For example, the desired outcome may be identified by performing a correlation process similar to correlation process 240 of FIG. 2C and/or by other methods.

The set of likely desired outcomes may be identified by correlating the first set of user actions with at least a portion of historical sets of user actions from the knowledge repository. The portion of historical sets of user actions may be based on an action of the first set of user actions (e.g., a trigger action), a user identifier, a time of day of an action of the first set of user actions, and/or other information related to the first set of user actions. For example, the knowledge repository may be managed using a database and the database may be queried using any pieces of information related to the first set of user actions in order to obtain the portion of historical sets of user actions. The set of likely desired outcomes may include any desired outcomes associated with the portion of historical sets of user actions.

A rank ordering of the historical sets of user actions may be obtained by generating a list of the (portion of) historical sets of user actions. For example, during correlation of the portion of historical sets of user actions and the first set of user actions, a correlation (e.g., a correlation value) may be obtained. The correlation may be obtained, for example, by comparing a graph representing a historical set of user actions to a graph of the first set of user actions. The correlation may indicate an extent to which the two graphs are related (e.g., a measure of similarity, a measure of relevance), with a higher correlation indicating a stronger relationship, and a lower correlation indicating a weaker relationship. The list of historical sets of user actions may be ordered by descending correlation value, so that the best ranked correlated set of historical user actions (e.g., with the highest correlation) is first on the list.

The desired outcome may be selected by (i) obtaining the list, (ii) querying (e.g., parsing) the list, and/or (iii) selecting the desired outcome based on a threshold (e.g., a minimum correlation value, a maximum number of elements (historical sets of user actions)). For example, the desired outcome may include one or more elements (e.g., desired outcomes) from the list, depending on the threshold and/or the number of elements on the list.

At operation 304, a trained machine learning model may be used to infer a second set of user actions. The second set of user actions may be inferred by (i) obtaining (e.g., identifying, generating) the trained machine learning model, (ii) providing input to the trained machine learning model (e.g., the input including the desired outcome and/or at least the first set of user actions), and/or (iii) obtaining an output from the trained machine learning model. For example, additional user actions may be performed by the user subsequent to the user performing the first set of user actions. The additional user actions may be used as input to the trained machine learning model. For more information regarding the trained machine learning model, refer to the discussion of FIG. 2B.

For example, inferring the second set of user actions may include ingesting data (e.g., at least one of the desired outcome and the first set of user actions) as input to the trained machine learning model to generate the second set of user actions as output from the trained machine learning model. At least one of the desired outcome and the first set of user actions may be ingested by the trained machine learning model by providing and/or otherwise making the data available to the trained machine learning model during an inferencing process. For more information regarding obtaining the second set of user actions, refer to the discussion of prediction process 242 of FIG. 2C.

At operation 306, performance of the second set of user actions may be automatically initiated to increase a likelihood of an occurrence of the desired outcome. The performance may be automatically initiated by performing a performance process similar to performance process 246 of FIG. 2C and/or by other methods. For example, automatically initiating performance of the second set of user actions may include (i) presenting the desired outcome and at least a second desired outcome to the user, and/or (ii) obtaining user input from the user indicating a preference with respect to the desired outcome and the at least the second desired outcome. For example, the desired outcome and the at least a second desired outcome may include the first two elements on the list obtained at operation 302.

The desired outcome and the at least a second desired outcome may be presented to the user by (i) obtaining (e.g., generating) instructions that generate human interpretable text and/or images (e.g., using a command line interface or a graphical user interface) representing the desired outcome and the at least a second desired outcome, and (ii) executing the instructions so that the user is presented with the human interpretable text and/or the images.

The user input may be obtained by (i) receiving the user input (e.g., prompting the user to make a selection regarding the desired outcome and the at least the second desired outcome), (ii) reading the user input (e.g., reading text, logging an interaction made by a mouse, finger, keyboard stroke), and/or (iii) interpreting the user input. For example, the interpretation of the user input may indicate that the preference is with respect to the desired outcome or the at least a second desired outcome.

In an instance of the obtaining of the user input where the user input indicates that the preference is with respect to the desired outcome, an automation framework hosted by the data processing system may be activated. For example, the automation framework may be activated to (i) perform the second set of user actions on behalf of the user, and/or (ii) to sequentially assist the user in performing actions of the second set of user actions.

The second set of user actions may be performed on behalf of the user by (i) obtaining (e.g., generating) instructions for performing at least one action of the second set of user actions, (ii) providing the instructions to the data processing system (e.g., an application running on the data processing system), and/or (iii) inserting the instructions into an execution flow of components of the data processing system, and/or (iv) other methods.

The second set of user actions may be used to sequentially assist the user by (i) obtaining human interpretable instructions (e.g., human interpretable text and/or images) for performing actions of the second set of user actions, (ii) presenting the human interpretable instructions to the user (e.g., via a user interface, via an instant message, via an email, and/or via other forms of communication), and/or (iii) other methods.

The method may end following operation 306.

Thus, as illustrated above, embodiments disclosed herein may provide systems and methods for managing a data processing system in a manner that provides automated support to a user of the data processing system. When the user performs a first set of actions that do not accomplish a desired outcome of the user, a second set of user actions may be predicted that, when performed, increase a likelihood of an occurrence of the desired outcome. By doing so, the second set of user actions may be used to provide the user with real-time automated support for accomplishing the desired outcome without relying on manual support methods that may be less efficient and/or less effective.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing a data processing system, the method comprising:
obtaining a first set of user actions performed by a user of the data processing system while the data processing system is providing computer-implemented services, the first set of user actions not accomplishing any desired outcomes of the user;
identifying a desired outcome of the user based on the first set of user actions and a knowledge repository that stores information regarding historical sets of user actions that lead to the any desired outcomes;
inferring, using a trained machine learning model, a second set of user actions based on the desired outcome and at least the first set of user actions; and
automatically initiating performance of the second set of user actions to increase a likelihood of an occurrence of the desired outcome.

2. The method of claim 1, wherein the first set of user actions is obtained while the user interacts with at least two applications hosted by the data processing system.

3. The method of claim 1, wherein identifying the desired outcome comprises:
identifying a set of likely desired outcomes based on correlations between the historical sets of user actions and the first set of user actions;
obtaining a rank ordering of the historical sets of user actions based on the correlations; and
selecting the desired outcome based on an association between a best ranked set of the historical sets of user actions and one of the desired outcomes.

4. The method of claim 1, wherein inferring the second set of user actions comprises:
ingesting at least one of the desired outcome and the first set of user actions as input to the trained machine learning model to generate the second set of user actions as output from the trained machine learning model.

5. The method of claim 4, wherein the trained machine learning model is based on a machine learning model architecture that is trained using the knowledge repository.

6. The method of claim 1, wherein automatically initiating performance of the second set of user actions comprises:
presenting the desired outcome and at least a second desired outcome to the user; and
obtaining user input from the user indicating a preference with respect to the desired outcome and the at least the second desired outcome.

7. The method of claim 6, wherein automatically initiating performance of the second set of user actions further comprises:
in an instance of the obtaining where the user input indicates that the preference is with respect to the desired outcome:
activating an automation framework hosted by the data processing system to perform the second set of user actions on behalf of the user.

8. The method of claim 6, wherein automatically initiating performance of the second set of user actions further comprises:
in an instance of the obtaining where the user input indicates that the preference is with respect to the desired outcome:
activating an automation framework hosted by the data processing system to sequentially assist the user in performing actions of the second set of user actions.

9. A non-transitory machine-readable medium having instructions stored therein, which when executed by a processor, cause the processor to perform operations for managing a data processing system, the operations comprising:
obtaining a first set of user actions performed by a user of the data processing system while the data processing system is providing computer-implemented services, the first set of user actions not accomplishing any desired outcomes of the user;
identifying a desired outcome of the user based on the first set of user actions and a knowledge repository that stores information regarding historical sets of user actions that lead to the any desired outcomes;
inferring, using a trained machine learning model, a second set of user actions based on the desired outcome and at least the first set of user actions; and
automatically initiating performance of the second set of user actions to increase a likelihood of an occurrence of the desired outcome.

10. The non-transitory machine-readable medium of claim 9, wherein the first set of user actions is obtained while the user interacts with at least two applications hosted by the data processing system.

11. The non-transitory machine-readable medium of claim 9, wherein identifying the desired outcome comprises:
identifying a set of likely desired outcomes based on correlations between the historical sets of user actions and the first set of user actions;
obtaining a rank ordering of the historical sets of user actions based on the correlations; and
selecting the desired outcome based on an association between a best ranked set of the historical sets of user actions and one of the desired outcomes.

12. The non-transitory machine-readable medium of claim 9, wherein inferring the second set of user actions comprises:
ingesting at least one of the desired outcome and the first set of user actions as input to the trained machine learning model to generate the second set of user actions as output from the trained machine learning model.

13. The non-transitory machine-readable medium of claim 12, wherein the trained machine learning model is based on a machine learning model architecture that is trained using the knowledge repository.

14. The non-transitory machine-readable medium of claim 9, wherein automatically initiating performance of the second set of user actions comprises:
presenting the desired outcome and at least a second desired outcome to the user; and
obtaining user input from the user indicating a preference with respect to the desired outcome and the at least the second desired outcome.

15. A data processing system, comprising:
a processor; and
a memory coupled to the processor to store instructions, which when executed by the processor, cause operations for managing a data processing system to be performed, the operations comprising:
obtaining a first set of user actions performed by a user of the data processing system while the data processing system is providing computer-implemented services, the first set of user actions not accomplishing any desired outcomes of the user,
identifying a desired outcome of the user based on the first set of user actions and a knowledge repository that stores information regarding historical sets of user actions that lead to the any desired outcomes,
inferring, using a trained machine learning model, a second set of user actions based on the desired outcome and at least the first set of user actions, and
automatically initiating performance of the second set of user actions to increase a likelihood of an occurrence of the desired outcome.

16. The data processing system of claim 15, wherein the first set of user actions is obtained while the user interacts with at least two applications hosted by the data processing system.

17. The data processing system of claim 15, wherein identifying the desired outcome comprises:
identifying a set of likely desired outcomes based on correlations between the historical sets of user actions and the first set of user actions;
obtaining a rank ordering of the historical sets of user actions based on the correlations; and
selecting the desired outcome based on an association between a best ranked set of the historical sets of user actions and one of the desired outcomes.

18. The data processing system of claim 15, wherein inferring the second set of user actions comprises:
ingesting at least one of the desired outcome and the first set of user actions as input to the trained machine learning model to generate the second set of user actions as output from the trained machine learning model.

19. The data processing system of claim 18, wherein the trained machine learning model is based on a machine learning model architecture that is trained using the knowledge repository.

20. The data processing system of claim 15, wherein automatically initiating performance of the second set of user actions comprises:
presenting the desired outcome and at least a second desired outcome to the user; and
obtaining user input from the user indicating a preference with respect to the desired outcome and the at least the second desired outcome.
